(19) United States
(12) Patent Application Publication
(10) Pub. No.: US 2010/0225730 A1
(43) Pub. Date: Sep. 9, 2010

(54) EXPOSURE DEVICE, IMAGE FORMING APPARATUS AND COMPUTER-READABLE MEDIUM

(75) Inventors: Michio TANIWAKI, Ebina-shi (JP); Ken TSUCHIYA, Ebina-shi (JP); Fumihiko OGASAWARA, Ebina-shi (JP); Toshio HISAMURA, Kawasaki-shi (JP); Osamu YASUI, Ebina-shi (JP); Michihiro INOUE, Ebina-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/615,661

(22) Filed: Nov. 10, 2009

(30) Foreign Application Priority Data
Mar. 6, 2009 (JP) 2009-052883

(51) Int. Cl. B41J 2/435

(52) U.S. Cl. 347/224

(57) ABSTRACT

According to an exposure device includes an exposure section, a lighting drive section, a first temperature detector and a second temperature detector. The exposure section has a plurality of light-emitting elements. The lighting drive section determines light-emitting energies of the respective light-emitting elements and drives to light the respective light-emitting elements in accordance with the determined light-emitting energies. The first temperature detector is provided in the exposure section. The second temperature detector is provided outside the exposure section. The lighting drive section determines the light-emitting energies of the respective light-emitting elements based on a temperature detected by the first temperature detector and a temperature detected by the second temperature detector.

### CROSS-REFERENCE TO RELATED APPLICATIONS

This application is based on and claims priority under 35 USC 119 from Japanese Patent Application No. 2009-52883 filed Mar. 6, 2009.

### BACKGROUND

### Technical Field

The present invention relates to an exposure device, an image forming apparatus, and a computer-readable medium storing a program that causes a computer to execute an exposure control process.

### SUMMARY

According to an exposure device includes an exposure section, a lighting drive section, a first temperature detector and a second temperature detector. The exposure section has a plurality of light-emitting elements. The lighting drive section determines light-emitting energies of the respective light-emitting elements and drives to light the respective light-emitting elements in accordance with the determined light-emitting energies. The first temperature detector is provided in the exposure section. The second temperature detector is provided outside the exposure section. The lighting drive section determines the light-emitting energies of the respective light-emitting elements based on a temperature detected by the first temperature detector and a temperature detected by the second temperature detector.

### BRIEF DESCRIPTION OF THE DRAWINGS

Exemplary embodiments of the invention will be described in detail based on the accompanying drawings, wherein

FIG. 1 is a view showing the entire configuration of an image forming apparatus according to an exemplary embodiment of the present invention;

FIG. 2 is a sectional view showing the configuration of an LED print head of the image forming apparatus according to one exemplary embodiment of the present invention;

FIG. 3 is a plan view of an LED array, having plural LED chips arranged therein, of the image forming apparatus according to one exemplary embodiment of the present invention;

FIG. 4 is a circuit diagram showing a light-emitting element array driving unit in the LED print head, for which a self-scanning LED is adopted, of the image forming apparatus according to one exemplary embodiment of the present invention;

FIG. 5 is a circuit diagram showing the light-emitting element array driving unit of the image forming apparatus according to one exemplary embodiment of the present invention;

FIG. 6 is a timing chart of operations of respective parts of the light-emitting element array of the image forming apparatus according to one exemplary embodiment of the present invention;

FIG. 7 is a view showing current flows in a level shift circuit when a transfer signal CK1R is turned from a default level to an L level in the image forming apparatus according to one exemplary embodiment of the present invention;

FIG. 8 is a view showing current flows immediately after the transfer signal CKS is turned to a H level and CK1C is turned to an L level in the image forming apparatus according to one exemplary embodiment of the present invention;

FIG. 9 is a view showing potentials of respective parts in a steady state where a thyristor S1 is completely turned on, in the image forming apparatus according to one exemplary embodiment of the present invention;

FIG. 10 is a view showing a state, where gate current flows through a thyristor S2, in the image forming apparatus according to one exemplary embodiment of the present invention;

FIG. 11 is a graph showing a relationship between fluctuations in temperature of the LED array and fluctuations in unevenness in the light amount in an experimental result;

FIG. 12 is a graph showing unevenness in the light amount at 28° C. in an experimental result;

FIG. 13 is a graph showing unevenness in the light amount at 48° C. in an experimental result;

FIG. 14 is a graph showing a relationship between elongation of the LED chip and fluctuations in unevenness in the light amount;

FIG. 15 is a view for explaining the graph of FIG. 14;

FIG. 16 is a graph showing a relationship between a initial length of the LED chip and a FFT temperature coefficient in an experimental result;

FIG. 17 is a graph showing a relationship between each four-dot group and a length of each four-dot group;

FIG. 18 is a view for explaining the graph of FIG. 17;

FIG. 19 is a graph showing a relationship between fluctuations in temperature of the LED array and fluctuations in unevenness in the light amount in an experimental result;

FIG. 20 is a circuit diagram for describing the configuration of circuits provided in a signal generation circuit, etc., in the image forming apparatus according to one embodiment of the present invention;

FIG. 21 is a graph showing operations of the circuits of FIG. 20 in the image forming apparatus according to one embodiment of the present invention;

FIG. 22 is a block diagram of electrical connections of a control section in the image forming apparatus according to one embodiment of the present invention; and

FIG. 23 is a schematic view for explaining the circuits of FIG. 20 in the image forming apparatus according to one embodiment of the present invention.

### DETAILED DESCRIPTION

Hereinafter, exemplary embodiments of the present invention of the invention will be described.

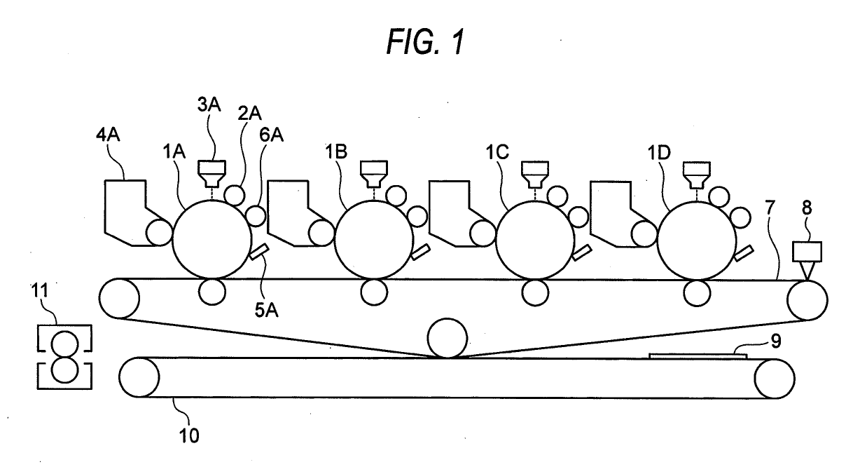

FIG. 1 is a view showing the entire configuration of an image forming apparatus according to an exemplary embodiment of the present invention.

The image forming apparatus is able to form a color image on a printing medium by a tandem type electrophotography system. The image forming apparatus is configured so that four drum-shaped photosensitive bodies 1A, 1B, 1C and 1D are arranged around an intermediate transfer belt 7. Various types of devices and units to form images by the electrophotography process are disposed around the photosensitive bodies 1A, 1B, 1C and 1D, respectively. Since the configurations of these devise and units are common to the photosensitive bodies 1A, 1B, 1C and 1D, herein, description is given of devices and units around the photosensitive body 1A as representative. That is, a charger 2A, a print head 3A, a developing device 4A, a cleaner 5A, and a charge neutralizer 6A are arranged around the photosensitive body 1A. A toner image is formed on the photosensitive body 1A with a yellow (Y) developing agent (also, in the following description, the photosensitive bodies 1A, 1B, 1C and 1D may be collectively referred to as the “photosensitive body” 1, and this is the same as for the charger 2A, the print head 3A, the developing device 4A, the cleaner 5A, and the charge neutralizer 6A). Similarly, toner images of magenta (M), cyan (C) and black (K) are formed on the photosensitive bodies 1B, 1C and 1D, respectively. The respective toner images are stacked on each other and transferred onto the intermediate transfer belt 7 while matching their positions based on detection signals of a registration sensor 8, and all the toner images are collectively transferred onto a recording sheet 9. The recording sheet 9 is conveyed to a fixing device 11 by means of a sheet conveyance belt 10. The fixing device 11 fixes the toner images on the recording sheet 9 (an example of a printing medium), thereby forming a color image.

Since, in such a tandem type color image forming apparatus, image forming units of respective colors Y, M, C and K are independently arranged, it may be required to downsize the respective units. Therefore, it may demanded for the print head that a space occupancy ratio around the photosensitive body circumference is downsized to as minimum extent as possible. An LED print head may be adopted, which uses an LED array in which a large number of light-emitting diodes (LEDs) (an example of light-emitting elements) are arranged.

In the following description, detailed description is given on an exposure device for exposing a surface of the photosensitive body 1 using the print head 3A.

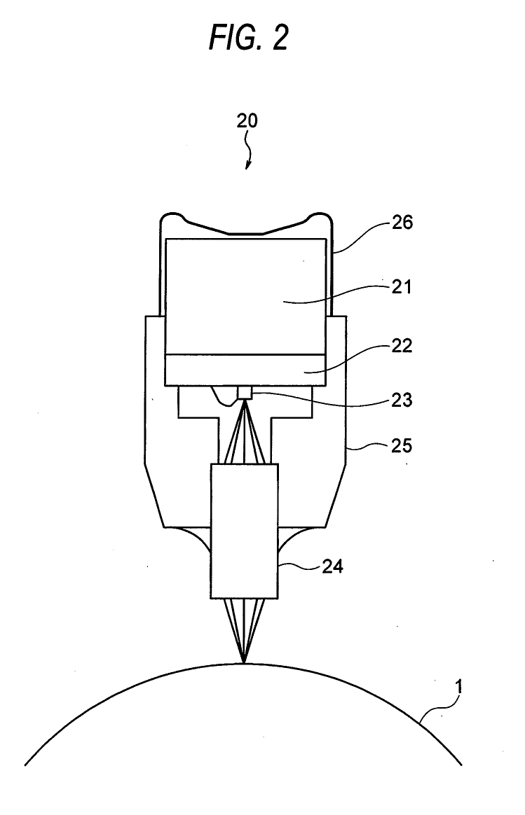

FIG. 2 is a sectional view showing the configuration of an LED print head.

The LED print head 20 is a light-emitting element for exposure of the photosensitive body and is provided on the print head 3. The LED print head 20 is provided with a housing 21 serving as a supporting body, a printed circuit board 22 having a light-emitting element array driver 50 (which will be described later) mounted thereon, an LED array 23 for emitting exposure light, a SELFOC® lens array (SELFOC lens is a registered trademark of Nippon Sheet Glass Co., Ltd.) for focusing light from the LED array 23 onto the surface of the photosensitive drum 1, a SELFOC lens array holder 25 for supporting the SELFOC lens array 24 and shielding the LED array 23 from the outside, and a leaf spring 26 for pressing the housing 21 in the SELFOC lens array 24 direction.

The housing 21 is formed of an aluminum or stainless steel block or made of an aluminum or stainless steel sheet material, and supports the printed circuit board 22 and the LED array 23. Also, the SELFOC lens array holder 25 supports the housing 21 and the SELFOC lens array 23, and is configured so that the light-emitting point of the LED array 23 is aligned with the focal point of the SELFOC lens array 24. Further, the SELFOC lens array holder 25 is disposed so as to closely seal the LED array 23. Therefore, no foreign substances such as dust are adhered to the LED array 23 from the outside. On the other hand, the leaf spring 26 presses in the direction of the SELFOC lens array 24 via the housing 21 so as to maintain the positional relationship between the LED array 23 and the SELFOC lens array 24.

The LED print head 20 is configured so as to be movable in an optical axis direction of the SELFOC lens array 24 by an adjustment screw (not illustrated), and is adjusted so that an image formation position (the focal point) of the SELFOC lens array 24 is located on the surface of the photosensitive drum 1.

In the LED array 23, as described later, plural LED chips 40 are accurately arranged on a chip substrate to form a row and to be parallel to a shaft direction of the photosensitive drum 1. In the SELFOC lens array 24, self-converging fibers are accurately arranged to form a row and to be parallel to the shaft direction of the photosensitive drum 1. And, light from the LED array 23 is focused on the surface of the photosensitive drum 1, and a latent image is formed thereon.

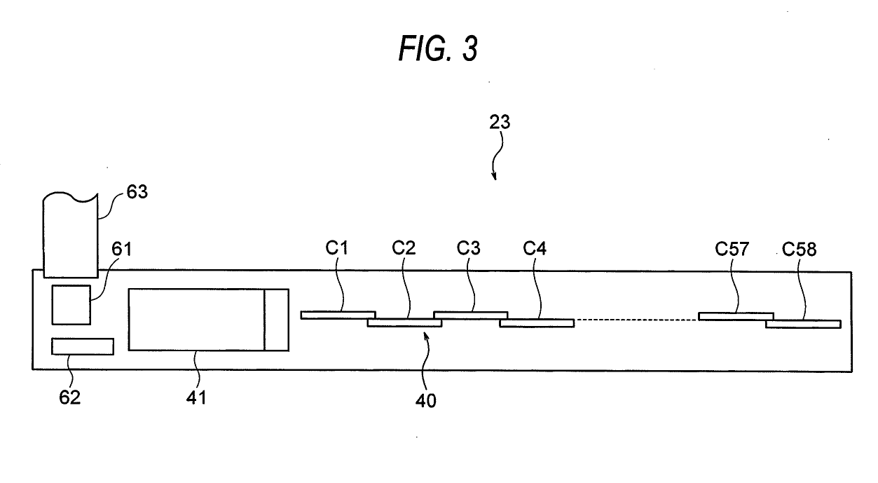

FIG. 3 is a plan view of the LED array 23 having plural LED chips 40 arranged therein.

In the LED array 23, 58 LED chips 40 (C1 through C58) are accurately arranged to form a row and to be parallel to the shaft direction of the photosensitive drum 1. The respective LED chips 40 are arrayed in a zigzag manner. And, in the LED print head 20, 256 LEDs are incorporated in each of the LED chips 40. In addition, the LED array 23 is provided with a driver 41 to drive the LED chips 40. Further, the LED array 23 is provided with a power circuit 61 to stabilize an output voltage, an EEPROM 62 to store light amount correction value data of the respective LEDs which constitute the LED chip 40, and a harness 63 for transmitting and receiving signals between the LED array 23 and an image forming apparatus main body.

Self-scanning LEDs are adopted in the LED print head 20. The self-scanning LED adopts a thyristor structure as a portion equivalent to a switch that selectively turns on and off a light-emitting point. By adopting the thyristor structure, it becomes possible to arrange the switching portion on the same chip as that of the light-emitting point, and turn-on timing and turn-off timing of the switch are selectively controlled for lighting by two signal lines. The data line can be made common, and the wiring thereof is simplified.

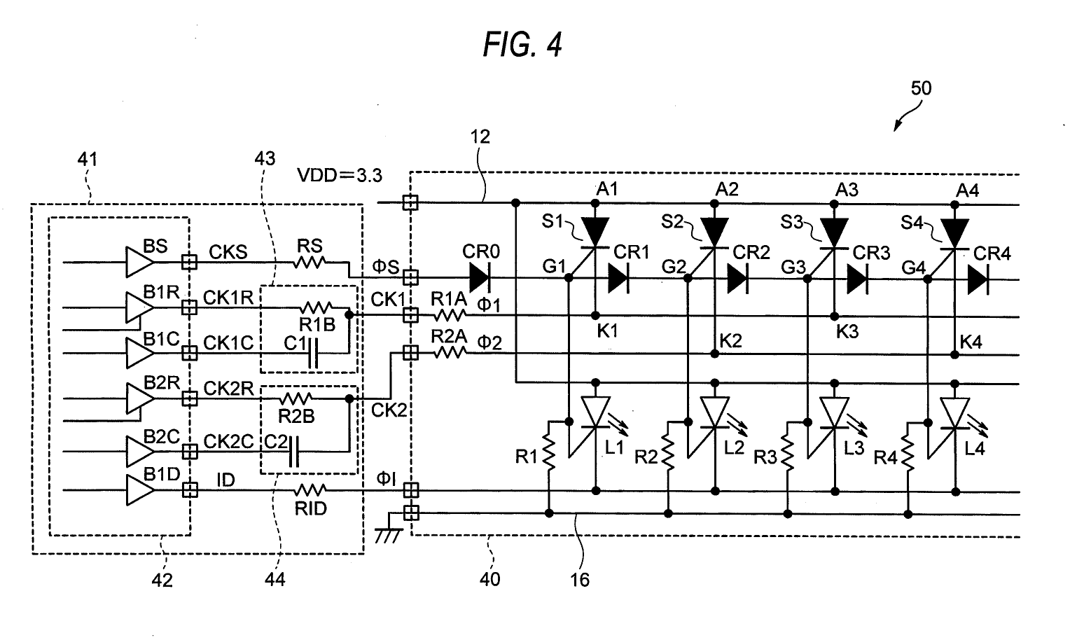

FIG. 4 is a circuit diagram showing the light-emitting element array driver 50 in the LED print head 20 in which the self-scanning LEDs are adopted.

In FIG. 4, the light-emitting element array driver 50 is provided with the LED chip 40 and the driver 41 to drive the LED chip 40. The LED chip 40 includes “n” thyristors S1, S2, . . . Sn (in the figure, the thyristors are appropriately illustrated by equivalent circuits), “n” light-emitting diodes (LEDs) L1, L2, . . . Ln, and “n+1” diodes CR0, CR1, CR2, . . . CRn, etc. In addition, the driver 41 includes resistors RS, R1B, R2B, RID, capacitors C1, C2 and a signal generation circuit 42, etc. Also, in FIG. 4, only some of the thyristors, the light-emitting diodes, and the diodes, which are provided in the LED chip 40, are illustrated.

Hereinafter, description is given on a circuit configuration of the LED chip 40 and the driver 41. Anode terminals A1 through An of the respective thyristors S1 through Sn are connected to the power line 12. A power voltage VDD (VDD=3.3V) is supplied to the power line 12. Cathode terminals K1, K3, . . . of the thyristors having an odd number (A1, A3, . . . ) are connected to the signal generation circuit 42 via the resistor R1A. A level-shift circuit 43 in which a signal line having the resistor R1B connected thereto and a signal line having the capacitor C1 connected thereto are branched in parallel to each other is connected between the resistor R1A and the signal generation circuit 42. Furthermore, cathode terminals K2, K4, . . . of the thyristors having an even number (S2, S4, . . . ) are connected to the signal generation circuit 42 via the resistor R2A. A level-shift circuit 44 in which a signal line having the resistor R2B connected thereto and a signal line having the capacitor C2 connected thereto are branched in parallel to each other is connected between the resistor R2A and the signal generation circuit 42.

On the other hand, gate terminals G1 through Gn of the respective thyristors S1 through Sn are connected to a power line 16 via resistors R1 through Rn which are provided so as to correspond to the respective thyristors S1 through Sn, respectively. In addition, the power line 16 is grounded (GND).

The gate terminals G1 through Gn of the thyristors S1 through Sn are, respectively, connected to the gate terminals of the light-emitting diodes L1 through Ln which are provided so as to correspond to the respective thyristors S1 through Sn.

Further, anode terminals of the diodes CR1 through CRn are connected to the gate terminals G1 through Gn of the respective thyristors S1 through Sn. Cathode terminals of the diodes CR1 through CRn are, respectively, connected to the gate terminals of the next stage. That is, the respective diodes CR1 through CRn are connected to each other in series.

The anode terminal of the diode CR1 is connected to the cathode terminal of the diode CR0, and the anode terminal of the diode CR0 is connected to the signal generation circuit 42 via the resistor RS. Further, the cathode terminals of the light-emitting diodes L1 through Ln are connected to the signal generation circuit 42 via the resistor RID. Still further, the light-emitting diodes L1 through Ln are composed of AlGaAsP or GaAsP as an example, and its band gap is approximately 1.5V.

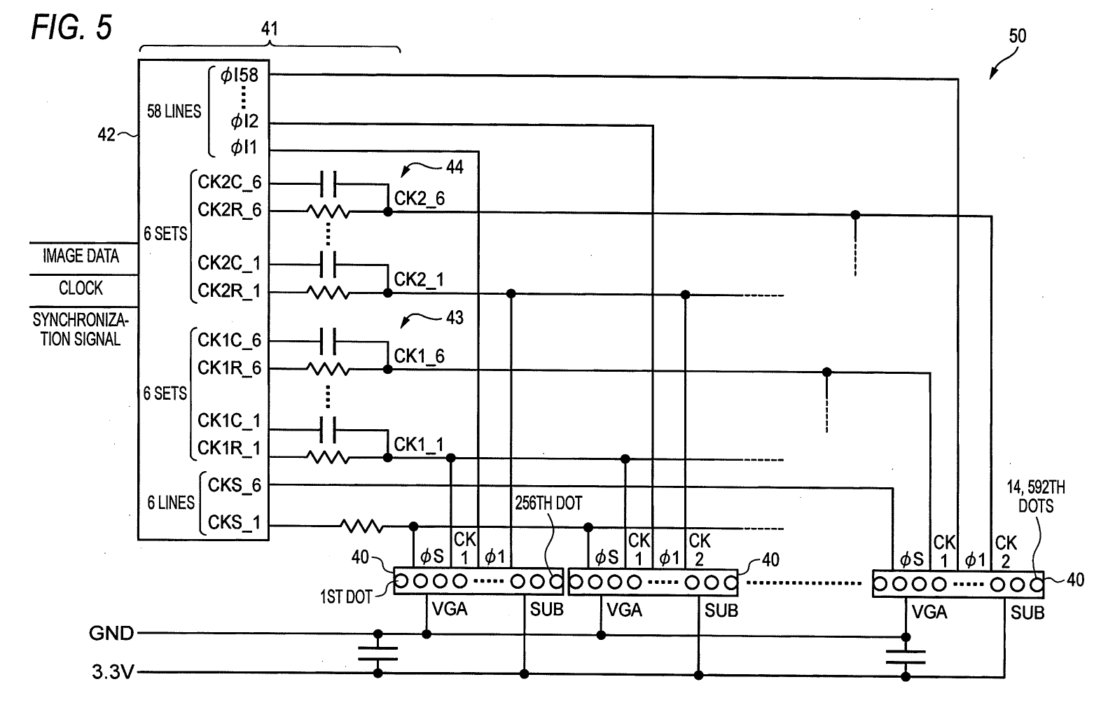

FIG. 5 is a circuit diagram showing the light-emitting element array driver 50.

FIG. 5 shows the configuration of recording on an A3-sized recording sheet at 1,200 dpi (dot per inch) and driving a 14592-dot LED element. That is, the LED print head 20 according to this exemplary embodiment has fifty seven LED chips 40, each of which is composed of 256 dots.

In FIG. 5, ID that is an LED lighting signal is provided for each LED chip 40, and 58 IDs are arranged in total. Also, each of the transfer signals CK1, CK2, CKS drive 9 or 10 chips. Six sets of the transfer signals CK1, CK2, CKS are arranged in total. The level shift circuits 43 and 44 (see FIG. 4) are provided for each of the sets. With this configuration, the drive capacity for each of the transfer signals CK1, CK2 and CKS is reduced, and all the LED chips 40 are driven in a stabilized state at a low voltage.

Self-scanning LEDs are adopted in the LED print head 20. The self-scanning LEDs employ the thyristor structure as a portion corresponding to a switch that selectively turns on and turns off the light-emitting points. By using the thyristor structure, the switching portions are disposed on the same chip as the light-emitting points. In addition, since the turn-on timing and turn-off timing of the switch are selectively controlled for lighting by two signal lines, wherein the data line can be made common, and the wiring thereof is simplified.

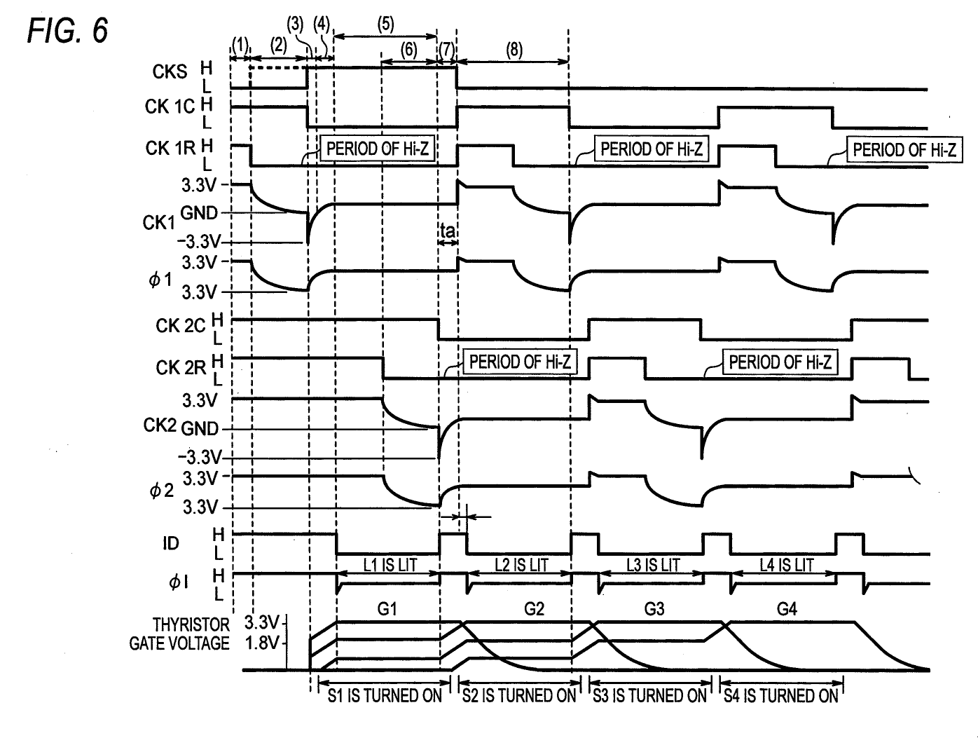

Next, description is given on operations of the light-emitting element array driver 50 shown in FIG. 4 with reference to a timing chart shown in FIG. 6. In FIG. 6, by showing the symbols, which are assigned to the signal lines in FIG. 4, it is made clear to which signals of the circuit in FIG. 4 the respective signals correspond. Also, in the following description, description is given on the case where four thyristors (n=4) are provided, as an example.

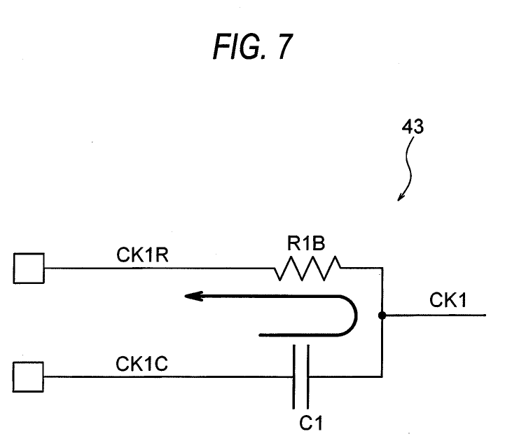

(1) First, in a default state, all the thyristors S1, S2, S3 and S4 are turned off since no current flows thereto (FIG. 6(1)).
(2) As the transfer signal CK1R is brought from the default state to an L level (FIG. 6(2)), current flows through the level shift circuit 43 in a direction of an arrow as shown in FIG. 7, and a potential of the transfer signal CK1 becomes GND. Since the potential of the transfer signal CK1 is 3.3V in this example, a potential difference between the both ends of the capacitor C1 is 3.3V (VDD). In this case, as shown by the dotted-line in the timing of FIG. 6(2), the transfer signal CKS may be set to a H level.
(3) Simultaneously therewith, if the transfer signal CKS is set to the H level and the transfer signal CK1C is set to an L level (FIG. 6(3)), the potential of the transfer signal CK1 becomes approximately −3.3V since electric charge is accumulated in the capacitor C1. Also, the potential of the gate G1 becomes φS potential−Vf=approximately 1.8V. Here, the φS potential is approximately 3.3V, and Vf means a forward direction voltage of the diode of AlGaAs and is approximately 1.5V. Further, φ1 potential=G1 potential−Vf=0.3V is brought about. Therefore, a potential difference of approximately 3.7V is produced between the signal line φ1 and the transfer signal CK1.

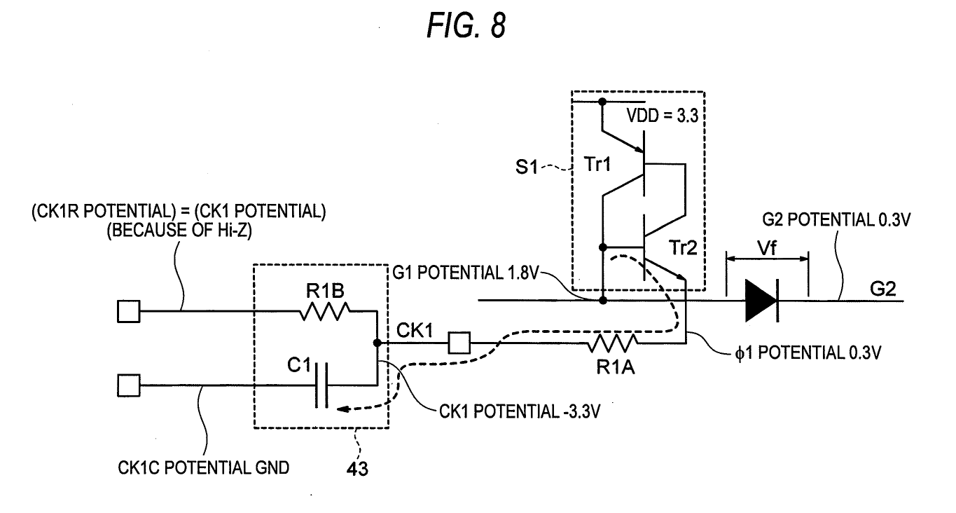

And, in this state, gate current of the thyristor S1 begins flowing in the route of the gate G1→signal line φ1→transfer signal CK1 as shown in FIG. 8. At this time, a tri-state buffer B1R is turned into a high impedance (Hi-Z), wherein reverse flow of the current is prevented.

After that, Tr2 is turned on by the gate current of the thyristor S1, and the base current of Tr1 (collector current of Tr2) is caused to flow, and Tr1 is turned on, thereby causing the thyristor S1 to start turning on, and the gate current to gradually rise. In line therewith, since current flows in the capacitor C1 of the level shift circuit 43, the potential of the transfer signal CK1 gradually rises.

(4) After a predetermined duration of time (that is, a time period in which the potential of the transfer signal CK1 is brought into the vicinity of GND) elapses, the tri-state buffer B1R of the signal generation circuit 42 is brought to an L level (FIG. 6(4)). If so, the potential of the signal line φ1 rises, and the potential of the transfer signal CK1 rises in line with a rise in the potential of the gate G1. Further, in line therewith, current begins flowing to the resistor R1B side of the level shift circuit 43. On the other hand, the current flowing in the capacitor C1 of the level shift circuit 43 gradually decreases in line with a rise in the potential of the transfer signal CK1.

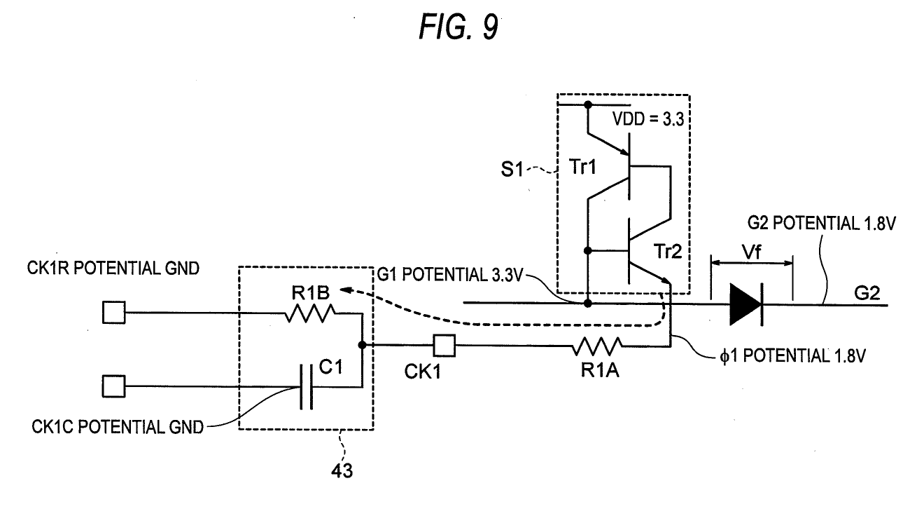

Then, as the thyristor S1 is completely turned on and is brought into a steady state, the potentials of the respective signal lines become as shown in FIG. 9. That is, although current to keep the thyristor S1 in a turned-on state flows in the resistor R1B of the level shift circuit 43, no current flows in the capacitor C1. Further, the potential of the transfer signal CK1 is CK1 potential=1.8-1.8×R1B/(R1A+R1B).

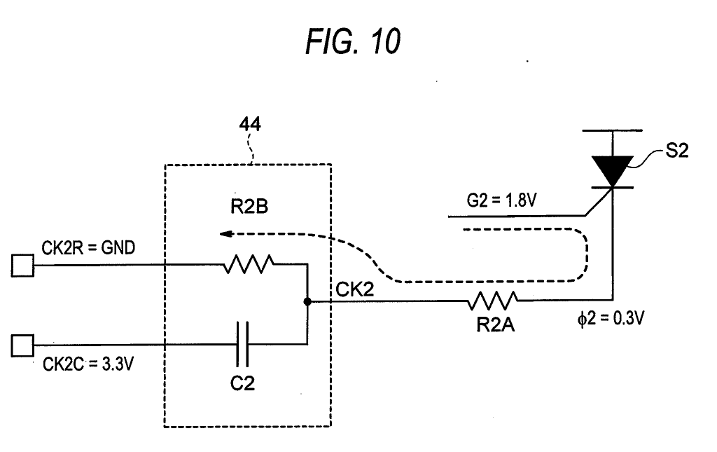

(5) The lighting signal ID is brought to an L level with the thyristor S1 being completely turned on (FIG. 6(5)). At this time, since the gate G1 potential is larger than the gate G2 potential (Gate G1 potential−Gate G2 potential=1.8V), the LED L1 of the thyristor structure is turned on earlier and is lit. In line with lighting of the LED L1, the potential of the signal line φ1 rises to cause signal line φ1 potential=gate G2 potential=1.8V to be brought about. Therefore, the LEDs including LED L2 and subsequent LEDs will not be turned on. That is, among the LEDs L1, L2, L3, L4 . . . , only the LED having the highest gate voltage is turned on (lit).
(6) Next, as the transfer signal CK2R is set to an L level (FIG. 6(6)), current flows as in the case of FIG. 6(2), and a voltage is generated between the both ends of the capacitor C2 of the level shift circuit 44. In a steady state immediately before the step of FIG. 6(6) is finished, since the gate G2 potential is 1.8V, the voltage values at the respective points slightly differ from those in the case of FIG. 6(2). However, no influence is brought about. The reason is as described below. The potential of the signal line φ2 is 0.3V or so (=Gate G2 potential−Vf=1.8V−1.5V) in a steady state immediately before the step of FIG. 6(6) is finished. Therefore, the gate current flows to the thyristor S2 in the dotted line direction as shown in FIG. 10. However, since this gate current is only slight, the thyristor S2 is not turned on. In this case, the transfer signal CK2 potential is roughly 0.15V or so (=CK2 potential=0.3-0.3×R2B/(R2A+R2B).
(7) If the transfer signal CK2C is set to an L level in this state (FIG. 6(7)), the thyristor switch S2 is turned on.
(8) Then, if the transfer signals CK1C and CK1R are simultaneously set to the H level (FIG. 6(8)), the thyristor switch S1 is turned off, and the gate G1 potential gradually falls by discharge through the resistor R1. At this time, the gate G2 of the thyristor switch S2 becomes 3.3V, and is completely turned on. Therefore, by bringing lighting signal ID terminals corresponding to image data to L level/H level, the LED L2 can be brought into lighting and non-lighting. Also, in this case, since the gate G1 potential has already been lower than the gate G2 potential, the LED L1 will not be turned on.

Thus, according to the light-emitting element array driver 50, since the ON state of the thyristor switches of the thyristors S1, S2, . . . Sn can be changed by alternately driving the transfer signals CK1 and CK2, the LEDs L1, L2, . . . Ln are selectively controlled for lighting or non-lighting through time sharing.

In the process of manufacturing the LED array 23, the LED chip 40 is attached onto a substrate by bonding the LED chip and the substrate via an adhesive. In this bonding process, the substrate and the LED chip 40 are heated to a high temperature and then are cooled down. Therefore, distortion may occur due to a difference in expansion rate between the substrate and the LED chip 40. Also, self heat generation of the LED array 23 and an increase in the environmental temperature cause fluctuation in light amount of the LEDs of the LED chip 40 because of this distortion. As a result, there may be cases where unintended light portion and/or unintended shade portion is produced in an image.

Next, description will be given on results of various experiments and measurements regarding fluctuations in light amount of the LEDs of such an LED chip 40.

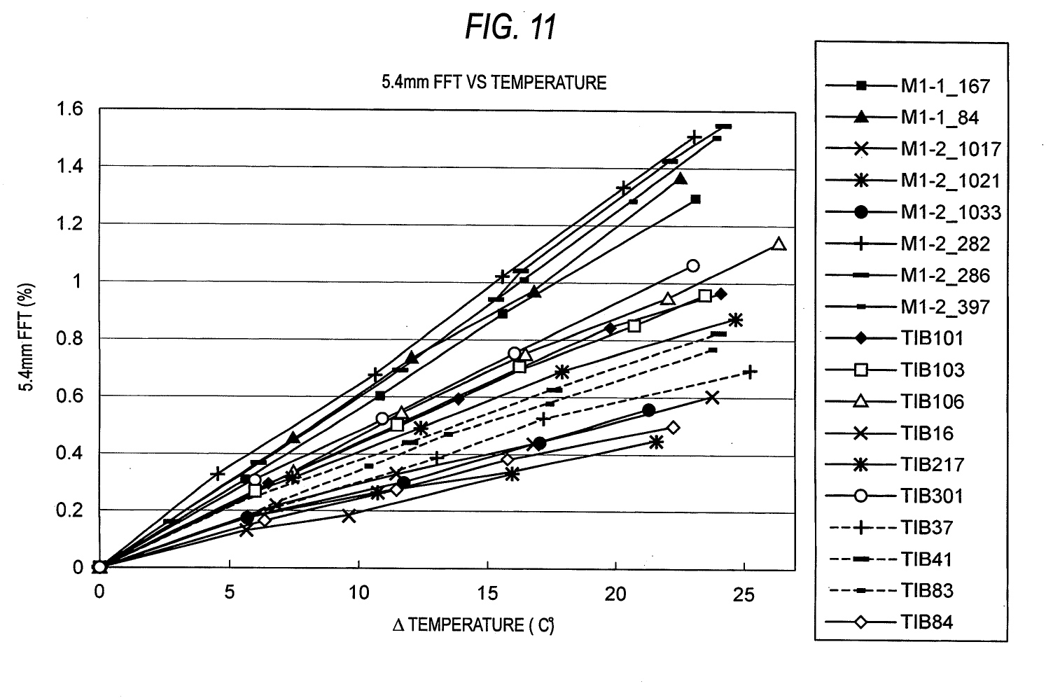

FIG. 11 is a graph showing a relationship between fluctuations in temperature of the LED array 23 and fluctuations in unevenness in light amount.

That is, in FIG. 11, the abscissa shows Δ temperature (Δ aluminum base temperature) of the LED array 23. Specifically, Δ temperature is defined as T₁−T₀ where T₀ (° C.) denotes an initial temperature and T₁ (° C.) denotes a variable. When the Δ temperature is 0° C., T₁ is equal to T₀. In this exemplary embodiment, T₀ is set to be in a range of from 27° C. to 30° C. It is assumed that temperatures are measured at an aluminum base of the LED array 23. M1-1₁₆₇, M1-1₈₄, M1-2₁₀₁₇, . . . TIB84 indicate samples of the LED array 23 and are different from each other in material of the substrate of the LED array 23.

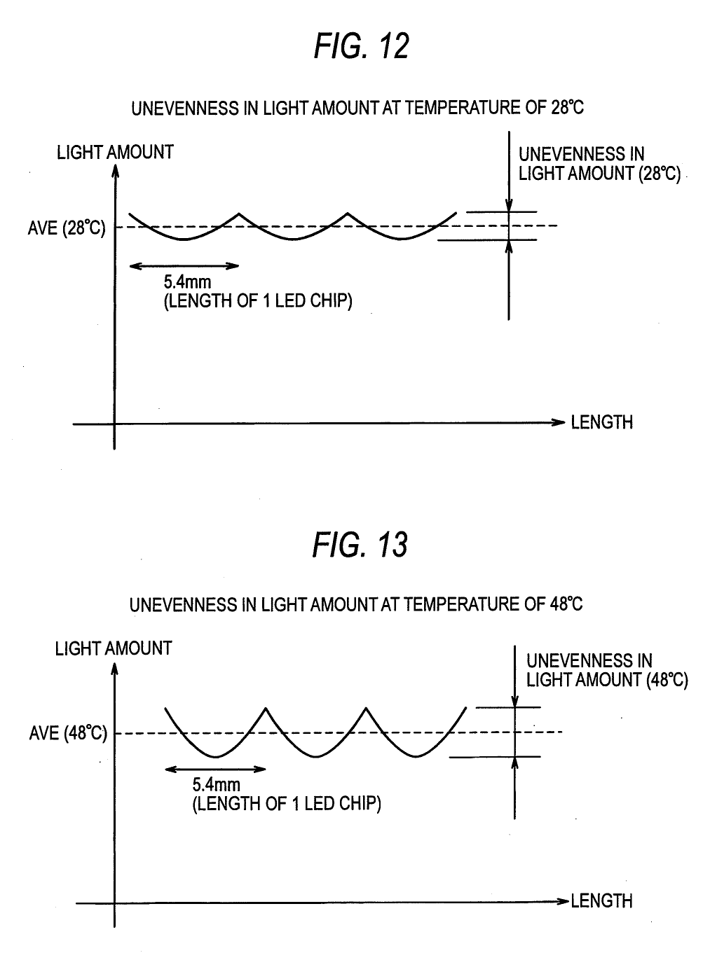

The expression “5.4 mm” on the abscissa means that the length of the LED chip 40 is 5.4 mm (this is the same for subsequent expressions). Also, 5.4 mm FFT of the ordinate indicates, in percentage, fluctuations in unevenness of the light amount of the LED chip 40 based on temperatures. That is, FIG. 12 shows unevenness in the light amount at 28° C., and an average value Ave of the light amount. FIG. 13 shows unevenness in the light amount at 48° C., and an average value Ave of the light amount. The abscissa shows the length, and a range of the length 5.4 mm of one LED chip 40 is shown by arrows. In this case, assuming that T₀=28° C.,

$$5.4 mm FFT ( Δ temperature = 20 °C ) = \frac{uneveness in light amount ( 48 °C )}{Ave ( 48 °C )} - \frac{uneveness in light amount ( 28 °C )}{Ave ( 28 °C )}$$

FIG. 11 shows that the percentage of the unevenness in the light amount of the LED array 23 increases as temperature increases and that an increase ratio depends on the material of the LED arrays 23.

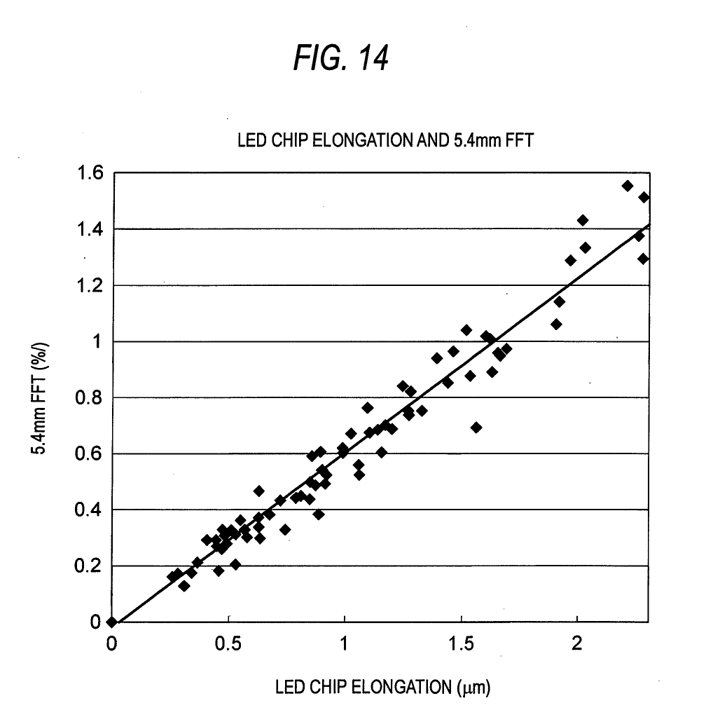

FIG. 14 is a graph showing a relationship between an elongation of the LED chip 40 and fluctuations in unevenness in the light amount.

The elongation of the LED chip 40 shown by the abscissa is represented by the following expression:

elongation of LED chip 40=(length of LED chip 40)−(length of LED chip 40 measured at reference temperature(25° C.))

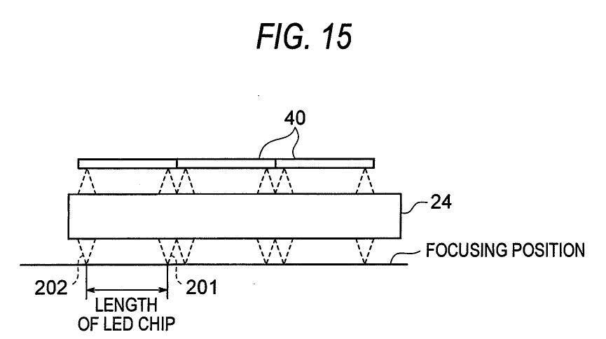

As shown in FIG. 15, the length of the LED chip 40 is defined such that

length of LED chip 40=(center of light spot 201 of right end dot of LED chip 40)−(center of light spot 202 of left end dot of LED chip 40)

It can be seen from FIG. 14 that if the elongation of the LED chip 40 gets larger, the unevenness in the light amount of the LED increases.

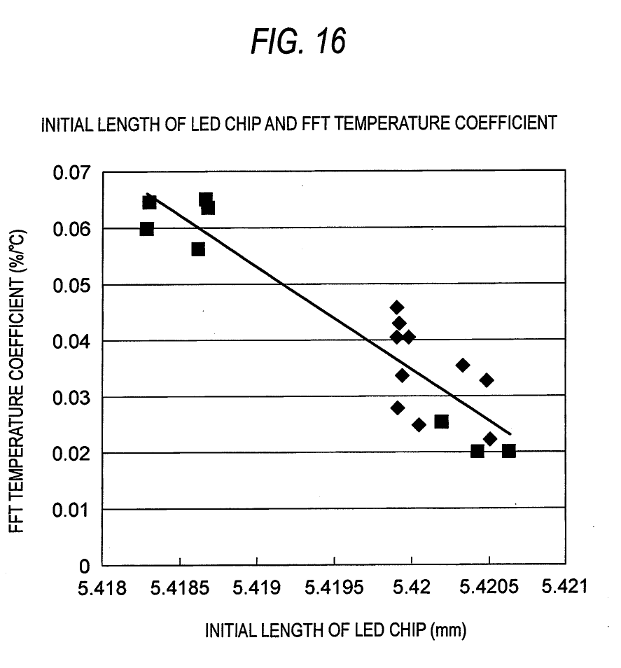

FIG. 16 is a graph showing a relationship between an initial length of the LED chip 40 and an FFT temperature coefficient.

Here, the initial length of the LED chip 40 shown by the abscissa is the length of the LED chip 40 measured at the reference temperature (for example, 25° C.). Also, the FFT temperature coefficient (%/° C.) shown by the ordinate is “FFT (%)/Δ temperature.” It can be seen from FIG. 16 that the elongation of the LED chip 40 correlates with the initial length of the LED chip 40.

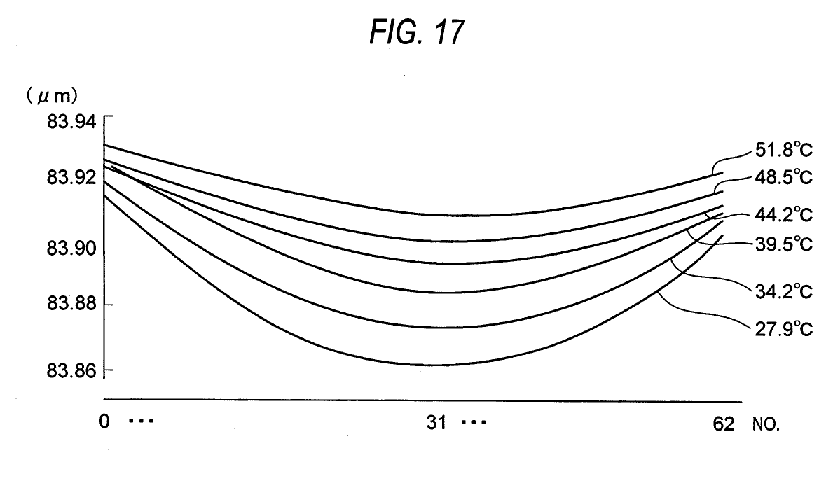

FIG. 17 is a graph showing a relationship between each four-dot group and a length of each four-dot group.

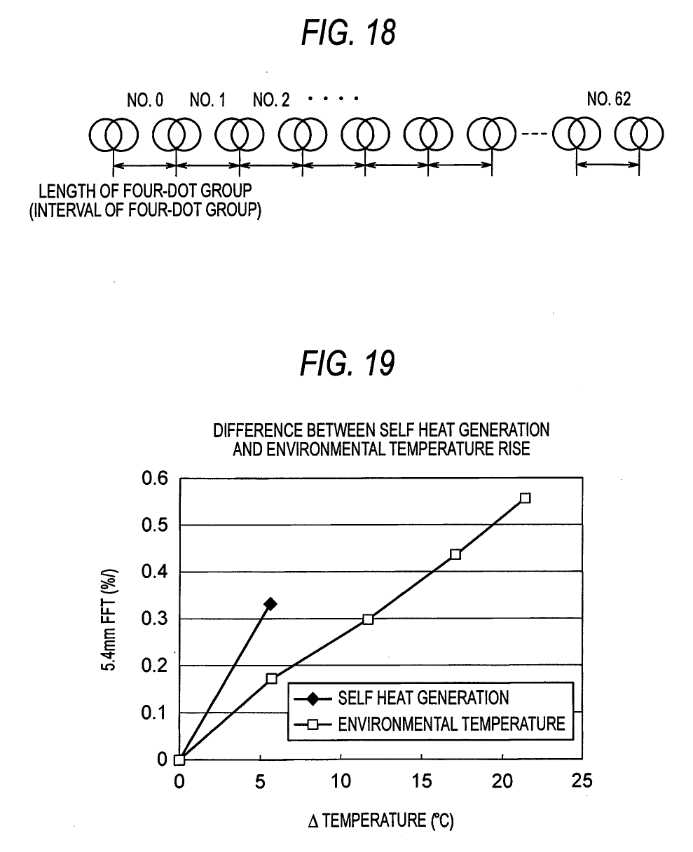

That is, each number in the abscissa has a four-dot group. For example, there are 20 dots (=4 dots×5) between the number “1” and the number “5”. Also, the ordinate shows a length of four dots in the LED chip 40. In FIG. 17, a length of 2ON/2OFF (equivalent to four dots) of the LED chips 40 composed of the material are averaged in terms of 57 LED chips 40 and plotted, and further curves in which the intervals are approximated by quadratic equations. It is noted that the term “2ON/2OFF” means that every two dots are turned on (e.g., first and second dots are turned on, and third and fourth dots are turned off). FIG. 17 shows the curves for different temperatures. FIG. 18 shows lengths of the four-dot groups in this case. One LED chip 40 is composed of 256 dots (1,200 dpi), and 2ON/2OFF is performed with such LED chips 40. FIG. 18 shows a state where light is emitted from one LED chip 40 in the 2ON/2OFF operation. Circles in FIG. 18 represent light emitted from the respective dots of the LED chip 40. Since the light is applied to the photosensitive body 1A (1B to 1D), light (circles) are drawn to overlap with each other. Each number (e.g. No. 0) shown in FIG. 18 denotes an adjacent interval (length) of 2ONs, specifically, denotes a distance between center of gravities of emission light of 2ONs. It is noted that No. 0, No 1, . . . No. 262 in FIG. 18 correspond to No. 0, No 1, . . . No. 262 (abscissa) in FIG. 17.

It can be seen from FIG. 17 that although the LED array 23 is greatly distorted at a normal temperature, but the stress of the LED chip 40 is released as the temperature rises over the normal temperature, and its distortion is relaxed. That is, it is understood that, although no fluctuation is brought about in the light amount of the respective LEDs of the LED array 23 at the normal temperature, the light amount may fluctuate because the distortion is relaxed in accordance with an increase in temperature.

FIG. 19 is a graph showing a relationship between temperature fluctuations of the LED array 23 and fluctuations in unevenness in the light amount.

In FIG. 19, the abscissa shows Δ temperature of the LED array 23, and the ordinate shows 5.4 mmFFT described above. FIG. 19 shows one case where the temperature rises due to self heat generation of the LED array 23, and another case where the temperature rises due to the environmental temperature. Temperatures are measured at the aluminum base of the LED array 23.

It can be seen from FIG. 19 that, even at the same temperature, there is a clear difference in magnitude of the unevenness in the light amount of the LED array 23 between the case where the temperature rises due to self heat generation of the LED array 23 and the case where the temperature rises due to the environmental temperature.

From the results shown in FIG. 11 and the subsequent figures described above, it can be understood about the unevenness in light amount of the LED array 23 that (1) even at the same temperature, there is a difference between the case where the temperature rises due to self heat generation of the LED array 23 and the case where the temperature rises due to the environmental temperature, and (2) the unevenness in light amount correlates with the initial length of the LED chip 40.

Therefore, taking the results described above into consideration, a description will be given on a circuit provided in an image forming apparatus according to this exemplary embodiment that can correct the unevenness in light amount in the respective LEDs of the LED array 23.

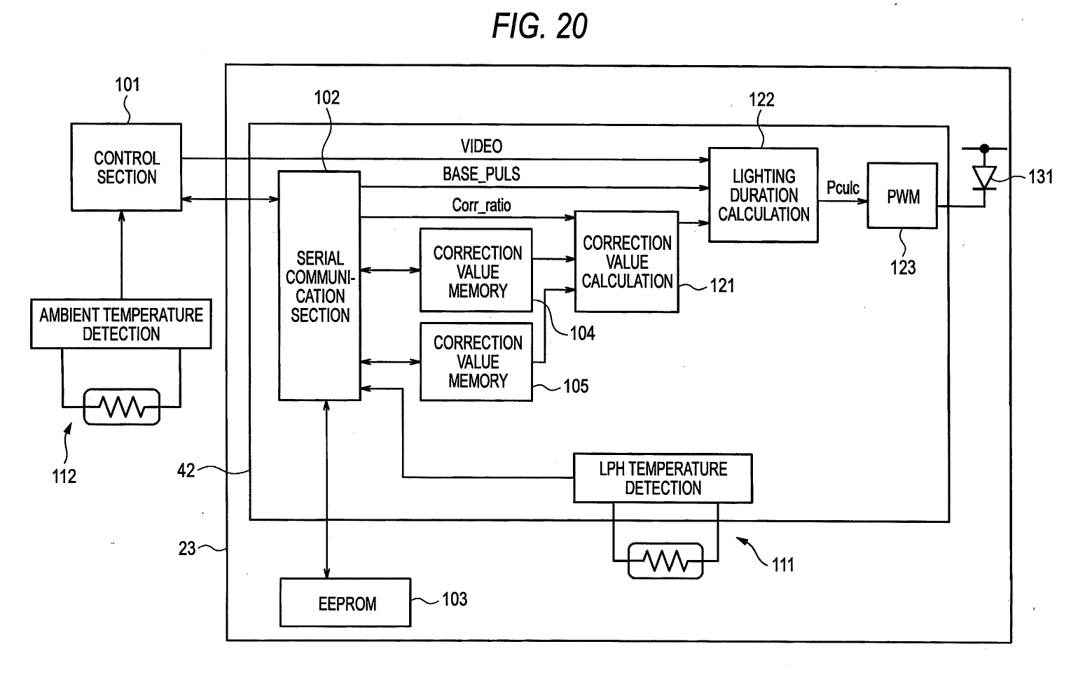

FIG. 20 is a circuit diagram showing the circuit configuration of the circuit provided in the signal generation circuit 42, etc.

A control section 101 controls an exposure device having the LED print head 20. The control section 101 communicates with a serial communication section 102 provided in the signal generation circuit 42. The control section 101 reads correction values A and correction values B from an EEPROM 103 when a main power source of the image forming apparatus is turned on, and stores the data (e.g., the correction values A and the correction values B) in correction value memories 104 and 105, respectively.

The correction values A are correction values used to correct the light amounts of the respective LEDs of the LED array 23 so that the respective LEDs uniformly emit light when the LED array 23 is located in the temperature environment of 25° C. The correction values B are correction values which are obtained from the initial lengths of the respective LED chips 40 and the correction values A for the respective LEDs and which are used to correct the light amounts of the respective LEDs so that the respective LEDs uniformly emit light when the LED array 23 is located in the high temperature environment. More specifically, a line CCD scans and reads the LED array 23 in the main scanning direction of the LED array 23, and the light amounts of the respective LEDs are corrected based on the scanning result when the image forming apparatus is shipped from the factory. At this time, position information of the respective LEDs is acquired. Since the length of each LED chip 40 can be obtained based on the acquired position information, the temperature coefficient of light amount fluctuation of each LED chip 40 is determined. Then, the correction value for the light amount of each LED at the time when the image forming apparatus is shipped from the factory is set as the correction value A, and the temperature coefficient of light amount fluctuation, which is obtained from the length of each LED chips 40, is set as the correction value B. For example, it is assumed that, if a reference temperature for light amount correction which is performed using the correction value A when the image forming apparatus is shipped from the factory is 25° C. and if the LED chip 40 is contracted by 1 μm as compared with the case where no stress is applied to the LED chip 40 (that is, as compared with the designed size of the LED chip 40), a predicted light amount correction value is given, as the correction value B, under the atmosphere of 50° C. It is further assumed that the length of the LED chip 40 is relaxed about 70% when the temperature is changed from 25° C. to 50° C., it is estimated that the elongation of the LED chip 40 is 0.7 μm in the atmosphere of 50° C., and the correction values B are set so that a unit amplitude of the LED chip 40 becomes 0.8% (peak-to-peak value; in units of the LED chips 40) (see FIG. 23). It is noted that how many percents the length of the LED chip 40 is relaxed when the temperature is changed from 25° C. to 50° C. depends on an adhesive used and a kind of a substrate. In this exemplary embodiment, 70% is obtained through an experiment in advance.

In addition, the control section 101 detects the temperature by means of temperature detectors 111 and 112. The temperature detector 111 is provided at the LED array 23, and detects the temperature brought about by self heat generation of the LED array 23. The temperature detector 112 is provided in a casing (for example, in the vicinity of the developer) of the image forming apparatus outside the LED array 23 and detects the environmental temperature around the LED array 23. The control section 101 determines a setting value Corrᵣₐₜᵢₒ based on the both temperatures.

As shown in FIG. 19, during operation of the LED array 23,

Amplitude of fluctuations in light amount due to self heat generation of LED array 23=(amplitude of fluctuations in light amount due to temperature detected by temperature detector 112)×2

Therefore, in this exemplary embodiment, the setting value Corrᵣₐₜᵢₒ is set as follows:

Corrᵣₐₜᵢₒ={(temperature detected by temperature detector 111−25° C.)×2+(temperature detected by temperature detector 112−25° C.)}÷(3×(50° C.−25° C.))

Here, 25° C. is the temperature when the light amounts of the LED array 23 are corrected, and the correction values A are obtained by measurement at 25° C. as described above. 50° C. is a temperature for the correction values B (measured values or predicted values). As described above, measured values or predicted values at 50° C. are given as the correction values B.

A correction value calculation section 121 calculates correction values by synthesizing the correction values A and B, which are stored in the correction value memories 104 and 105, in accordance with the setting value Corrᵣₐₜᵢₒ.

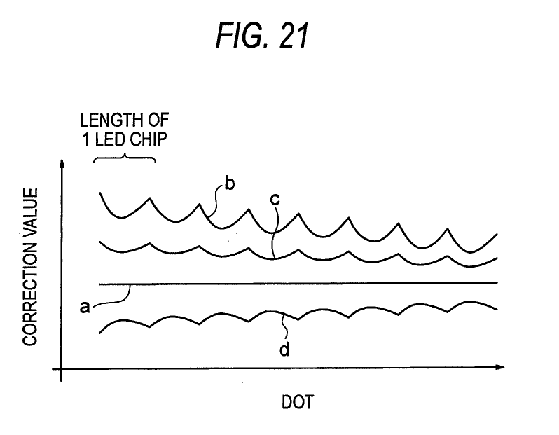

FIG. 21 is a graph for explaining the correction values obtained by the correction value calculation section 121.

In FIG. 21, the abscissa shows dots of respective LEDs of the LED array 23, and the ordinate shows the correction value. The graph “a” shows the correction values A, and the graph “b” shows the correction values B. When the setting value Corrᵣₐₜᵢₒ is equal to 1 (for example, when both of the temperature detected by the temperature detector 111 and the temperature detected by the temperature detector 112 are 50° C.), the correction values calculated by the correction value calculation section 121 become the same as the correction values B in the graph “b”. The graph “c” shows the correction values calculated by the correction value calculation section 121 when the setting value Corrᵣₐₜᵢₒ is equal to 0.5 (for example, when the temperature detected by the temperature detector 111 is 40° C. and the temperature detected by the temperature detector 112 is 32.5° C.). The graph “d” shows the correction values calculated by the correction value calculation section 121 when the setting value Corrᵣₐₜᵢₒ is −0.5 (for example, when the temperature detected by the temperature detector 111 is 15° C. and the temperature detected by the temperature detector 112 is 7.5° C.). It is noted that when both of the temperature detected by the temperature detector 111 and the temperature detected by the temperature detector 112 are 25° C., the setting value Corrᵣₐₜᵢₒ becomes equal to 0.

The control section 101 transmits image data (video signals) and BASE_{PULS} signals to a lighting duration calculation section 122. The BASE_{PULS} signals are signals for setting the light amounts for the respective LEDs 131 of the LED chip 40, which are base light amounts before the light amounts are corrected. The lighting duration calculation section 122 calculates lighting durations of the respective LEDs 131 based on the correction values given from the correction value calculation section 121, the image data (Video signals) and the BASE_{PULS} signals. The respective LEDs 131 are driven for lighting by a PWM control circuit 123 in accordance with the determined lighting durations, to thereby control the light amounts of the respective LEDs 131. That is, the light amount control is implemented by controlling the lighting durations of the respective LEDs 131. The light durations of the respective LEDs 131 are ones of examples that determine lighting energies of the respective LEDs 131.

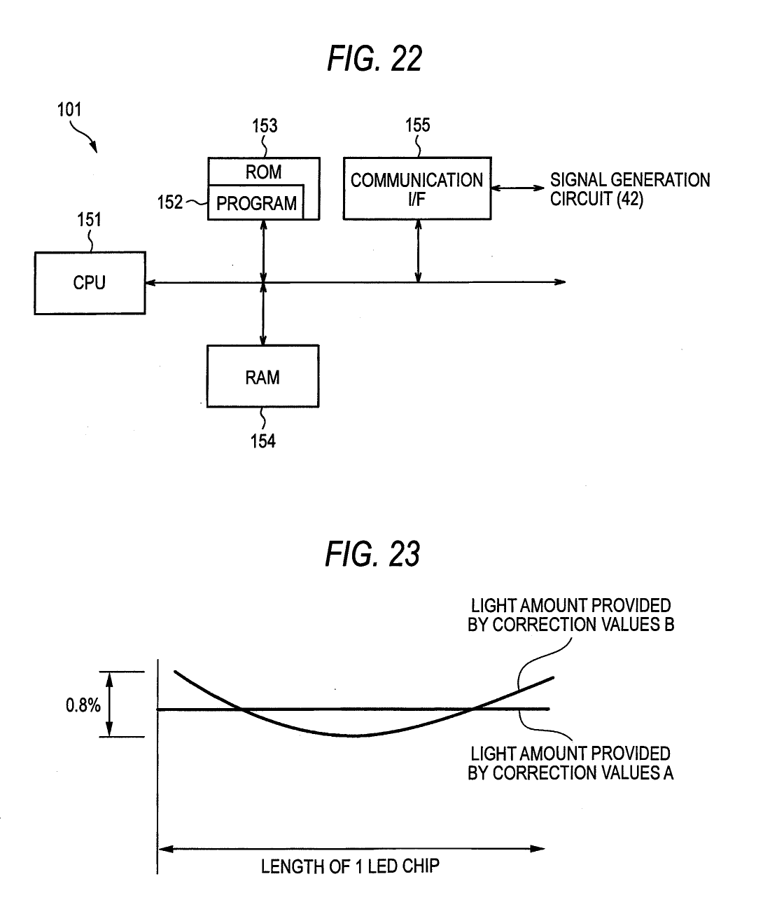

FIG. 22 is a block diagram of electrical connections of the control section 101.

The above-described operations are executed under control of the control section 101. The control section 101 is provided with a CPU 151 for intensively controlling respective sections. A ROM 153 storing control programs 152 executed by the CPU 151, and fixed data, a ROM 154 serving as a working area of the CPU 151, and a communication interface (I/F) 155 for executing communications with the signal generation circuit 42 are connected to the CPU 151.

The control program 152 may be set up at the beginning of production of the image forming apparatus. However, the control program 152 may be read out later from a storage medium (e.g., CD-ROM, DVD-ROM or the like) having the control program 152 stored therein, and be set up in a non-volatile memory or a magnetic memory unit. Alternatively, the control program 152 may be downloaded in the form of carrier waves from a communication tool such as the Internet and be set up in a non-volatile memory or a magnetic memory unit of the control section 101.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An exposure device comprising:
an exposure section having a plurality of light-emitting elements;
a lighting drive section that determines light-emitting energies of the respective light-emitting elements and drives to light the respective light-emitting elements in accordance with the determined light-emitting energies;
a first temperature detector provided in the exposure section; and
a second temperature detector provided outside the exposure section, wherein
the lighting drive section determines the light-emitting energies of the respective light-emitting elements based on a temperature detected by the first temperature detector and a temperature detected by the second temperature detector.

2. The exposure device according to claim 1, further comprising:
a first memory that stores first correction values used to correct the light-emitting energies of the respective light-emitting elements; and
a second memory that stores second correction values that are determined based on a length of an element in which the plurality of light-emitting elements provided in the exposure section are arrayed, wherein
the lighting drive section obtains third correction values based on the first correction values, the second correction values, and the temperatures detected by the first temperature detector and the second temperature detector, and determines the light-emitting energies of the respective light-emitting elements based on the third correction values.

3. An image forming apparatus comprising:
a photosensitive body;
an exposure device including a plurality of light-emitting elements that expose the photosensitive body to form an electrostatic latent image on the photosensitive body; and
a developing device that develops the electrostatic latent image with a toner, wherein
the exposure device includes
an exposure section having the plurality of light-emitting elements,
a lighting drive section that determines light-emitting energies of the respective light-emitting elements and drive to light the respective light-emitting elements in accordance with the determined light-emitting energies,
a first temperature detector provided in the exposure section, and
a second temperature detector provided outside the exposure section,
the lighting drive section determines the light-emitting energies of the respective light-emitting elements based on a temperature detected by the first temperature detector and a temperature detected by the second temperature detector.

4. A computer-readable medium storing an exposure control program that causes a computer to execute an exposure control process, the exposure control process comprising:
controlling an exposure device including
an exposure section having a plurality of light-emitting elements,
a lighting drive section that determines light-emitting energies of the respective light-emitting elements and drive to light the respective light-emitting elements in accordance with the determined light-emitting energies,
a first temperature detector provided in the exposure section, and
a second temperature detector provided outside the exposure section; and
controlling the lighting drive section to determine the light-emitting energies of the respective light-emitting elements based on a temperature detected by the first temperature detector and a temperature detected by the second temperature detector.
